(19) United States
(12) Patent Application Publication
(10) Pub. No.: US 2023/0116816 A1
(43) Pub. Date: Apr. 13, 2023

(54) APPARATUS AND METHOD FOR EDGE-STRENGTH ENHANCED GLASS

(71) Applicant: CORNING INCORPORATED, CORNING, NY (US)

(72) Inventors: Yen-Kai Huang, Taipei City (TW); Bernhard Anton Moegele, Landsberg am Lech (DE); Uwe Stute, Neustadt am Rübenberge (DE); Ralf Joachim Terbrueggen, Neuried (DE)

(21) Appl. No.: 17/961,897

(22) Filed: Oct. 7, 2022

Related U.S. Application Data
(60) Provisional application No. 63/254,721, filed on Oct. 12, 2021.

(51) Int. Cl. C03B 33/02; C03B 33/08; B23K 26/21

(52) U.S. Cl. CPC C03B 33/0222; C03B 33/082; B23K 26/21

(57) ABSTRACT

A method including emitting a laser beam toward a transparent workpiece such that portions of the laser beam pass through openings of a beam shaping structure and form corresponding laser beam focal lines across the transparent workpiece. The laser beam focal lines forming a plurality of defects in the transparent workpiece disposed along a contour line. The method further including separating the transparent workpiece along the contour line to provide a first workpiece section and a second workpiece section and a cut edge surface on each of the first and second workpiece sections, each cut edge including a defect region and an unaffected region. The defect region having a higher surface roughness than the unaffected region and a minimum distance of the unaffected region to the first major surface being about 20% or less of a thickness between the first major surface and the second major surface.

### BACKGROUND

This application claims the benefit of priority under 35 U.S.C § 120 of U.S. Provisional Application Ser. No. 63/254,721 filed on Oct. 12, 2021, the content of which is relied upon and incorporated herein by reference in its entirety.

Silica-based materials such as glass or quartz are useful for many technological applications because of their advantageous optical properties, low coefficient of thermal expansion, and flexibility. For example, glass is used as a protective cover for capacitive touch screens, such as the cover glass for thin-film transistor (TFT) displays.

Laser processing of materials, such as via the controlled interaction of laser light with the material, encompasses a wide variety of applications that involve cutting, drilling, milling, welding, melting and the like. One process that is of interest is the cutting and separating of transparent substrates, such as glass, sapphire, or fused silica, such as those that are used for TFT displays.

From process development and cost perspectives, there are many opportunities for improvement in cutting and separating of transparent substrates. It is of great interest to have faster, cleaner, cheaper, more repeatable, and more reliable methods of cutting and separating transparent substrates, such as glass substrates. Accordingly, a need exists for improved methods of cutting and separating transparent substrates.

### SUMMARY OF THE DISCLOSURE

The present disclosure describes methods for cutting strengthened glass to provide for enhanced edge strength for the resulting glass article. The methods described herein use laser energy to produce a specified laser focus area at the cut edge, which forms a patterned edge. The patterned edge provides for the enhanced edge strength with a simplified manufacturing process.

According to a first aspect, a method of producing an article, the method comprising positioning a beam shaping structure relative to a transparent workpiece, the transparent workpiece having a first major surface and a second major surface, the first major surface opposing the second major surface with a thickness therebetween, wherein the beam shaping structure comprises a specified pattern of openings and emitting a laser beam toward the first major surface of the transparent workpiece such that portions of the laser beam pass through the openings and form corresponding laser beam focal lines across a portion of the transparent workpiece. A length of each laser beam focal line being less than the thickness of the transparent workpiece, and the laser beam focal lines forming a plurality of defects in the transparent workpiece disposed along a contour line. The method further comprises separating the transparent workpiece along the contour line to provide a first workpiece section and a second workpiece section. The separating of the transparent workpiece forms a cut edge surface on each of the first and second workpiece sections, each cut edge comprising a defect region and an unaffected region, the defect region having a higher surface roughness than the unaffected region and a minimum distance of the unaffected region to the first major surface being about 20% or less of the thickness between the first major surface and the second major surface.

According to another aspect, an article comprising a transparent workpiece comprising a first major surface and a second major surface, the first major surface opposing the second major surface with a thickness therebetween. An edge surface of the transparent workpiece comprises a defect region and an unaffected region, the defect region having a higher surface roughness than the unaffected region and a minimum distance of the unaffected region to the first major surface being about 20% or less of the thickness between the first major surface and the second major surface.

According to another aspect, a method of producing an article, the method comprising positioning a beam shaping structure relative to a first transparent workpiece and a second transparent workpiece. The first transparent workpiece contacting the second transparent workpiece at a contact region, the first transparent workpiece having a first thickness and the second transparent workpiece having a second thickness, the first transparent workpiece having a first major surface and a second major surface, and the beam shaping structure comprising a specified pattern of openings. The method further comprises emitting a laser beam toward the first major surface of the first transparent workpiece such that portions of the laser beam pass through the openings and form a corresponding laser beam focal line across the contact region. A length of the laser beam focal line being less than the thickness of first transparent workpiece and the thickness of the second transparent workpiece combined.

### BRIEF DESCRIPTION OF THE DRAWING

The drawing illustrates generally, by way of example, but not by way of limitation, various embodiments discussed in the present document.

FIG. 1 is a schematic cross-sectional view of an exemplary laser system for cutting a transparent workpiece using a quasi-non-diffracting laser beam.

FIG. 2 is a schematic perspective view of a portion of the exemplary laser system and transparent workpiece of FIG. 1.

FIG. 3 is a top view of a plurality of exemplary laser-formed defects within a transparent workpiece after laser processing and before separation.

FIG. 4 is an end view of an edge of a transparent workpiece after laser processing and separating the transparent workpiece with the exemplary laser system of FIGS. 1 and 2.

FIG. 5 is a schematic cross-sectional side view of an exemplary laser processing system for cutting a transparent workpiece according to the present disclosure.

FIG. 6 is a schematic perspective view of the exemplary laser processing system of FIG. 5.

FIG. 7 is an end view of a first patterned edge of an exemplary transparent workpiece formed after laser processing and separating the transparent workpiece.

FIG. 8 is a schematic cross-sectional side view of an alternative exemplary laser processing system for cutting a transparent workpiece according to the present disclosure.

FIG. 9 is an end view of a second patterned edge of an exemplary transparent workpiece formed after laser processing and separating the transparent workpiece.

FIG. 10 is a schematic cross-sectional side view of another exemplary laser processing system for cutting a transparent workpiece according to the present disclosure.

FIG. 11 is an end view of a third patterned edge of a transparent workpiece formed after laser processing and separating the transparent workpiece.

FIG. 12 is a schematic perspective view of another exemplary laser processing system for cutting a transparent workpiece according to the present disclosure.

FIG. 13 is an end view of a fourth patterned edge of a transparent workpiece formed after laser processing and separating the transparent workpiece.

FIG. 14 is an end view of a fifth patterned edge of a transparent workpiece formed after laser processing and separating the transparent workpiece.

FIG. 15 is an end view of a sixth patterned edge of a transparent workpiece formed after laser processing and separating the transparent workpiece.

FIG. 16 is an end view of a seventh patterned edge of a transparent workpiece formed after laser processing and separating the transparent workpiece.

FIG. 17 is a schematic cross-sectional side view of an exemplary laser processing system for joining two transparent workpieces together according to the present disclosure.

### DETAILED DESCRIPTION

The following detailed description describes methods and systems of producing a glass article with enhanced edge strength as well as the resulting glass articles. The systems and methods use a specified laser focal area pattern to form nano-perforation-like laser-cut traces in a specified pattern. The specified pattern can allow the laser-modified glass to be separated into separate glass sections each comprising an edge pattern that corresponds to the specified laser focal area pattern. The specified edge pattern includes one or more first regions each comprising laser-cut defects (also referred to herein as “defect regions”) and one or more second regions that are not altered by the laser (also referred to herein as “unaffected regions”) that can, in embodiments, produce a smooth mirror-like surface. At least a portion of the second region or regions comprising the mirror-like surface or surfaces are in a near-surface area of the glass article that is within a specified distance from at least one of the major surfaces of the glass article.

The description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The example embodiments may be combined, other embodiments may be utilized, or structural, and logical changes may be made without departing from the scope of the present invention. While the disclosed subject matter will be described in conjunction with the enumerated claims, it will be understood that the exemplified subject matter is not intended to limit the claims to the disclosed subject matter. The following detailed description is, therefore, not to be taken in a limiting sense, and the scope of the present invention is defined by the appended claims and their equivalents.

References in the specification to “one embodiment”, “an embodiment,” “an example embodiment,” etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a concentration range of “about 0.1% to about 5%” should be interpreted to include not only the explicitly recited concentration of about 0.1 wt. % to about 5 wt. %, but also the individual concentrations (e.g., 1%, 2%, 3%, and 4%) and the sub-ranges (e.g., 0.1% to 0.5%, 1.1% to 2.2%, and 3.3% to 4.4%) within the indicated range. The statement “about X to Y” has the same meaning as “about X to about Y,”” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. Unless indicated otherwise, the statement “at least one of” when referring to a listed group is used to mean one or any combination of two or more of the members of the group. For example, the statement “at least one of A, B, and C” can have the same meaning as “A; B; C; A and B; A and C; B and C; or A, B, and C,” or the statement “at least one of D, E, F, and G” can have the same meaning as “D; E; F; G; D and E; D and F; D and G; E and F; E and G: F and G; D, E, and F; D, E, and G; D, F, and G; E, F, and G; or D, E, F, and G.” A comma can be used as a delimiter or digit group separator to the left or right of a decimal mark; for example, “0.000,1”” is equivalent to “0.0001.”

In the methods described herein, the steps can be carried out in any order without departing from the principles of the invention, except when a temporal or operational sequence is explicitly recited. Furthermore, specified steps can be carried out concurrently unless explicit language recites that they be carried out separately. For example, a recited act of doing X and a recited act of doing Y can be conducted simultaneously within a single operation, and the resulting process will fall within the literal scope of the process. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E (including with one or more steps being performed concurrent with step A or Step E), and that the sequence still falls within the literal scope of the claimed process. A given step or sub-set of steps can also be repeated.

Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

The term “about” as used herein can allow for a degree of variability in a value or range, for example, within 10%, within 5%, within 1%, within 0.5%, within 0.1%, within 0.05%, within 0.01%, within 0.005%, or within 0.001% of a stated value or of a stated limit of a range, and includes the exact stated value or range.

The term “substantially” as used herein refers to a majority of, or mostly, such as at least about 50%, 60%, 70%, 80%, 90%, 95%, 96%, 97%, 98%, 99%, 99.5%, 99.9%, 99.99%, or at least about 99.999% or more, or 100%.

In addition, it is to be understood that the phraseology or terminology employed herein, and not otherwise defined, is for the purpose of description only and not of limitation. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

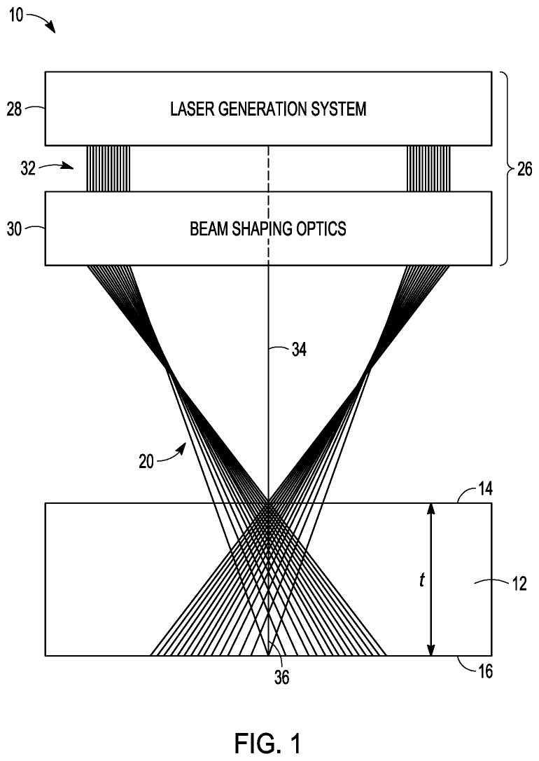

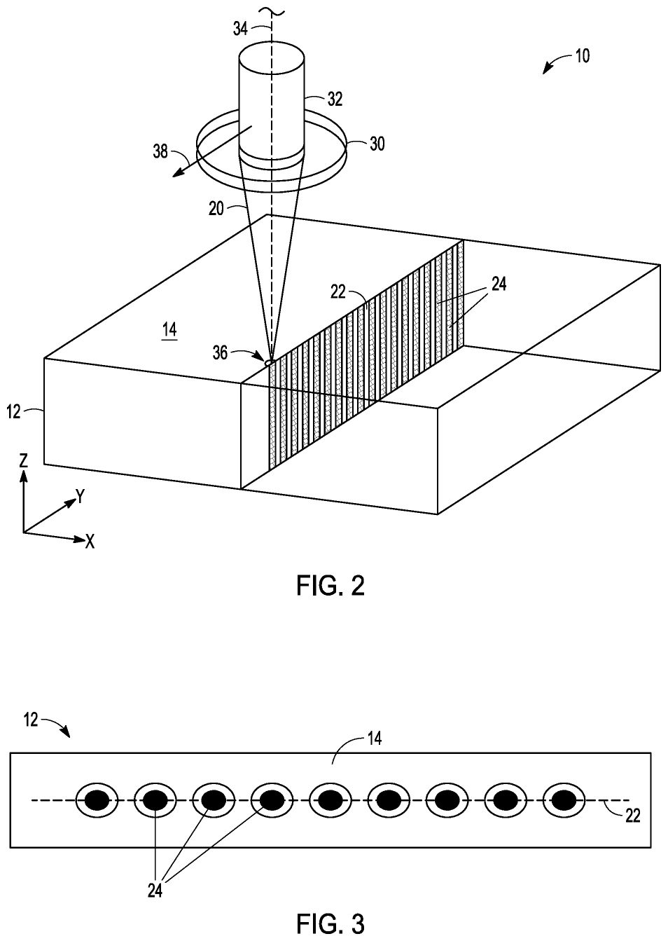

FIGS. 1 and 2 show views of an exemplary laser processing system 10 for laser processing a transparent workpiece 12. As used herein, the term “laser processing” comprises directing a laser beam onto and/or into a transparent workpiece. In some examples, laser processing further comprises translating the laser beam relative to the transparent workpiece, for example along a contour line, along a contour, or along another pathway. Examples of laser processing include using a defect forming laser beam (such as a pulsed laser beam) to form a contour comprising a series of defects that extend into the transparent workpiece and, optionally, using an infrared laser beam to heat the transparent workpiece for the purpose of separation into two or more pieces along one or more desired lines of separation. However, in some examples, additional, non-laser steps can be utilized to separate the transparent workpiece along one or more desired lines of separation.

The term “transparent workpiece,” as used herein, refers to a workpiece formed from a glass, a ceramic, a glass-ceramic, or other material that is transparent to a specified wavelength or wavelengths, such as to light within the visible spectrum. The term “transparent,” as used herein, refers to a material that has an optical absorption of less than about 20% per mm of material depth, such as less than about 10% per mm of material depth, for example less than about 1% per mm of material dept for the specified wavelength or wavelengths. Unless otherwise specified, the material has an optical absorption of less than about 20% per mm of material depth. The transparent workpiece can have a depth (e.g., a thickness t) of from about 50 microns to about 10 mm, such as from about 100 microns to about 5 mm, or from about 0.5 mm to about 3 mm.

Transparent workpieces can comprise glass workpieces formed from glass compositions including, but not limited to, borosilicate glass, soda-lime glass, aluminosilicate glass, alkali aluminosilicate glass, alkaline earth aluminosilicate glass, alkaline earth boro-aluminosilicate glass, fused silica, or crystalline materials such as sapphire, silicon, gallium arsenide, zinc selenide, or combinations thereof. In some examples, the transparent workpiece can be strengthened via thermal tempering before or after laser processing the transparent workpiece. For example, the glass of the transparent workpiece can be heated to a high temperature followed by rapid cooling. The large temperature shift causes glass near the surface to compress, while an inner core is tensioned. The compressed outer zones are tougher than the original, non-tempered transparent workpiece.

In some examples, the glass can be ion-exchangeable, such that the glass composition can undergo ion-exchange for glass strengthening before or after laser processing the transparent workpiece. For example, the transparent workpiece can comprise ion exchanged and ion exchangeable glass, such as Corning Gorilla® Glass available from Corning Incorporated of Corning, N.Y., USA (e.g., code 2319, code 2319, and code 2320 glass). Further the ion-exchanged glasses can have coefficients of thermal expansion (CTE) of from about 6 ppm/° C. to about 10 ppm/° C. Other examples of transparent workpieces including EAGLE XG® and CORNING LOTUS™ available from Corning Incorporated.

In an ion exchange process, ions in a surface layer of the transparent workpiece are replaced by larger ions having the same valence or oxidation state, for example, by partially or fully submerging the transparent workpiece in an ion exchange bath. Replacing smaller ions with larger ions can cause a layer of compressive stress to extend from one or more surfaces of the transparent workpiece to a certain depth within the transparent workpiece, referred to as the “depth of layer.” The compressive stresses are balanced by a layer of tensile stresses (also referred to as “central tension”) such that the net stress in the glass sheet is zero. The formation of compressive stresses at the surface of the glass sheet makes the glass sheet strong and resistant to mechanical damage and, as such, can mitigate catastrophic failure of the glass sheet for flaws which do not extend through the depth of layer. In some examples, ion exchange comprises exchanging smaller sodium ions (Na⁺ in the surface layer of the transparent workpiece with larger potassium ions (K⁺). In some examples, the ions in the surface layer and the larger ions are monovalent alkali metal cations such as lithium ions (Li⁺) (when present in the glass), sodium ions (Na⁺), potassium ions (K⁺), rubidium ions (Rb⁺), and cesium ions (Cs⁺). Alternatively, monovalent cations in the surface layer can be replaced with monovalent cations other than alkali metal cations, such as silver ions (Ag⁺), thallium ions (TI⁺), and copper (I) ions (Cu⁺), or the like.

In an example, the transparent workpiece 12 is a glass sheet, such as a glass substrate for a display panel, for example the cover glass of a touchscreen display. For the sake of brevity, for the remainder of this disclosure, when referring to a transparent workpiece such as the transparent workpiece 12, the term “the glass sheet” will be used. Those having ordinary skill in the art will appreciate that if the term “glass sheet” is used, the concepts of the present disclosure can also apply to other transparent workpieces, such as those described above. In an example, the glass sheet 12 includes a first major surface 14 and an opposing second major surface 16 with a thickness t extending between the first major surface 14 and the second major surface 16. In an example, the glass sheet 12 comprises a strengthened glass, e.g., thermally tempered or chemically strengthened glass. As will be appreciated by those having skill in the art, in an example, the strengthened glass sheet 12 can comprise at least one tensile stress layer, at least one compression stress layer, and at least one interface region between the at least one tensile stress layer and the at least one compression stress layer.

The example glass sheet 12 can be cut by a laser beam configured to interact with a transparent substrate, such as the glass sheet 12, along a laser propagation direction that can result in elongated modified regions within the material, also referred to herein as “elongate internal damage regions,” “damage regions,” or “defects.” Directing or localizing the defect forming laser beam into the glass sheet 12 generates an induced absorption within the glass sheet 12 and deposits enough energy to break chemical bonds in the glass sheet 12 at spaced locations along a contour line to form the defects. It has been found that producing these internal modified regions along a separation line over a specified range of thickness in the material and/or at a specific position within the material and/or at a specific distance from each other and/or with a specific diameter allows for influencing the cleaving behavior of the material across the separation line. It has been found that producing these internal modified regions can even allow for cleaving of tempered glass after thermal tempering or ion exchange treatment of the glass sheet 12. In addition, it has been found that producing the internal modified regions across the thickness of the glass substrate can allow for cleaving parts of the glass substrate with a high-degree of precision and with a high-quality cut face, as discussed further below.

In an example, the laser-cutting method comprises single-pass cutting using a laser beam having a quasi-non-diffracting beam, such as a Bessel-like beam configuration. As used herein, the term “quasi-non-diffracting beam” is used to describe a laser beam having low beam divergence as described below. The quasi-non-diffracting laser beam can be formed by impinging a diffracting laser beam (such as a Gaussian beam) into, onto, and/or through a phase-altering optical element, such as an adaptive phase-altering optical element (e.g., a spatial light modulator, an adaptive phase plate, a deformable mirror, or the like) and/or a static phase-altering optical element (e.g., a static phase plate, an aspheric optical element, such as an axicon, or the like), to modify the phase of the beam, to reduce beam divergence, and to increase Rayleigh range, as defined below. Example quasi-non-diffracting beams include Gauss-Bessel beams, Airy beams, Weber beams, and Bessel beams.

Without intending to be limited by theory, beam divergence refers to the rate of enlargement of the beam cross section in the direction of beam propagation (i.e., the Z direction). Diffraction is one factor that leads to divergence of laser beams. Other factors include focusing or defocusing caused by the optical systems forming the laser beams or refraction and scattering at interfaces. Laser beams for forming the defects of the contours disclosed herein are formed from laser beam focal lines. Such laser beam focal lines have low divergence and weak diffraction. The divergence of the laser beam is characterized by the Rayleigh range Z^{R}, which is related to the variance σ2 of the intensity distribution and beam propagation factor M² of the laser beam. In the discussion that follows, equations will be presented using a Cartesian coordinate system. Corresponding expressions for other coordinate systems are obtainable using mathematical techniques known to those of skill in the art. Additional information on beam divergence can be found in the articles entitled “New Developments in Laser Resonators” by A.E. Siegman in SPIE Symposium Series Vol. 1224, p. 2 (1990) and “M² factor of Bessel-Gauss beams” by R. Borghi and M. Santarsiero in Optics Letters, Vol. 22(5), 262 (1997), the disclosures of which are incorporated herein by reference in their entirety. Additional information can also be found in the international standards ISO 11146-1:2005(E) entitled “Lasers and laser-related equipment-Test methods for laser beam widths, divergence angles and beam propagation ratios-Part I: Stigmatic and simple astigmatic beams,” ISO 11 146-2:2005(E) entitled “Lasers and laser-related equipment-Test methods for laser beam widths, divergence angles and beam propagation ratios-Part 2: General astigmatic beams”, and ISO 11 146-3:2004(E) entitled “Lasers and laser-related equipment-Test methods for laser beam widths, divergence angles and beam propagation ratios-Part 3: Intrinsic and geometrical laser beam classification, propagation and details of test methods,” the disclosures of which are incorporated herein by reference in their entirety.

As shown in FIG. 1, a laser processing system 10 is disclosed that comprises a laser system 26 comprising a laser generation system 28 and a beam shaping optics 30. The laser generation system 28 is configured to deliver a pulsed laser beam 32 along a beam pathway 34 comprising short laser pulses of a specifically adjustable temporal duration. In embodiments, the beam shaping optics 30 focus the pulsed laser beam 32 into a quasi-non-diffracting laser beam 20 that acts along a laser beam focal line 36 within the glass sheet 12. As discussed above, the glass sheet 12 has first major surface 14 and second major surface 16.

Quasi-non-diffracting beams, such as laser beam 20, (including zero-order Bessel beams, for example) can feature an intense central spot that persists in a propagation direction substantially without apparent diffraction. This is in contrast to the focusing of standard Gaussian beams, which are usually strongly diverging after a tight focus. Accordingly, single-laser quasi-non-diffracting beam pulses result in interaction zones that produce very narrow, needle-like laser damage regions within the glass substrate.

As will be appreciated by those having skill in the art, Bessel-like beams are characterized by concentric fringes in the radial intensity profile. Bessel-like beams can have, for example, a transverse intensity profile of a zeroth order Bessel beam. In addition, radially truncated Bessel-like beams can be generated when passing the beam through a diaphragm or any radially limiting optical element, which creates, for example, so-called apodized Bessel beams. In some embodiments of the present disclosure, Bessel-like beams can be generated from Gaussian beams.

For cutting of thick glass substrates, according to embodiments of the present disclosure, Bessel-like beams having a very long, non-diffracting zone can be used. When maintaining the aperture of optical elements within an optical system, longer condensed-beam zones (i.e., longer “non-diffracting zones”) can be achieved by reducing the cone angle of the Bessel-like beam. Moreover, it has been discovered that for a given duration of laser pulses, a defined limit exists for the minimum cone angle of the Bessel-like beam above which elongated damage is caused that is capable of leading to precise single-shot and single-pass material laser cutting.

In embodiments, the laser processing system 10 is configured to process the glass sheet 12 to form a contour line 22 comprising a series of defects 24 (shown in FIGS. 2 and 3). The contour line 22 defines a line of intended separation of the glass sheet 12 into two or more portions. As used herein, the term “contour line” refers to a line (e.g., a linear, angled, polygonal, or curved line, etc.) formed along a desired line of separation on the surface of the glass sheet 12 along which the glass sheet 12 can be separated into multiple portions upon exposure to the appropriate processing conditions. In an example, the contour line 22 comprises a plurality of the laser-generated defects 24. As used herein, the term “defect” can include an area of modified material relative to the bulk material, a void space, a scratch, a flaw, a hole, or any other deformity in the glass sheet 12 that enables separation. The defects 24 may also be referred to hereinafter as “line defects,” “damage regions,” elongate internal damage regions,” “perforations,” or “nano-perforations.”

The defects 24 are each formed by the laser beam 20 being directed onto a single position of the glass sheet 12, e.g., along the contour line 22, for a single laser pulse or multiple pulses at the same location. Translating the laser beam 20 along the contour line 22 results in multiple defects 24 that form a contour along the counter line 22. As used herein, the term “contour” refers to a set of defects 24 in the glass sheet 12 formed by translating a laser along the contour line 22. As used herein, a contour refers to a shape or path in or on a substrate. The contour can be manifest, for example, by a fault line or a crack. A contour defines a surface of desired separation in the glass sheet 12. A contour can be formed by creating a plurality of the defects 24 in the glass sheet 12 by laser processing the glass sheet 12 (such as by directing a pulsed laser beam at successive points along the contour line 22). Multiple contours can be used to create complex shapes, as can lasers with curved focal lines. Examples of the complex shapes that can be formed include a beveled surface of separation. For a line focus laser, each defect 24 can have a linear or substantially linear shape.

As used herein, the term “laser beam focal line” (or simply “focal line”) refers to a pattern of interacting (e.g., crossing) light rays of a laser beam that form a linear, elongate focused region that is parallel or substantially parallel to an optical axis. In embodiments, the focal line 36 comprises aberrated light rays that interact (e.g., cross) the optical axis of the laser beam at different positions along the optical axis. In an example, the laser beam focal lines described herein are formed using quasi-non-diffracting beams having low beam divergence, as defined below, by propagating the pulsed laser beam 32 through the beam shaping optics 30

As will be understood by those having skill in the art, the length of a quasi-non-diffracting beam is determined by its Rayleigh range. Particularly, the quasi-non-diffracting beam defines a laser beam focal line having a first end point and a second end point each defined by locations where the quasi-non-diffracting beam has propagated a distance from the beam waist equal to a Rayleigh range of the quasi-non-diffracting beam. A detailed description of the formation of quasi-non-diffracting beams and determining their length, is provided in U.S. Provisional Application Ser. No. 62/402,337 and Dutch Patent Application No. 2017998, which are incorporated herein by reference in their entireties.

The Rayleigh range corresponds to the distance (relative to the position of the beam waist as defined in Section 3.12 of ISO 11146-1:2005(E)) over which the variance of the laser beam doubles (relative to the variance at the position of the beam waist) and is a measure of the divergence of the cross-sectional area of the laser beam. The Rayleigh range can also be observed as the distance along the beam pathway 34 at which the peak optical intensity observed in a cross-sectional profile of the beam decays to one half of its value observed in a cross-sectional profile of the beam at the beam waist location (location of maximum intensity). The quasi-non-diffracting beams disclosed herein each define a laser beam focal line having a first end point and a second end point. The first and second end points of the quasi-non-diffracting beams are defined as the locations where each quasi-non-diffracting beam has propagated a distance from the beam waist equal to a Rayleigh range of the quasi-non-diffracting beam. Laser beams with large Rayleigh ranges have low divergence and expand more slowly with distance in the beam propagation direction than laser beams with small Rayleigh ranges.

Beam cross section is characterized by shape and dimensions. The dimensions of the beam cross section are characterized by a spot size of the beam. For a Gaussian beam, spot size is frequently defined as the radial extent at which the intensity of the beam decreases to 1/e² of its maximum value. The maximum intensity of a Gaussian beam occurs at the center (x=0 and y=0 (Cartesian) or r=0 (cylindrical)) of the intensity distribution and radial extent used to determine spot size is measured relative to the center.

Non-diffracting or quasi-non-diffracting beams generally have complicated intensity profiles, such as those that decrease non-monotonically versus radius. By analogy to a Gaussian beam, an effective spot size woe can be defined for any beam, even non-axisymmetric beams, as the shortest radial distance, in any direction, from the radial position of the maximum intensity (r=0) at which the intensity decreases to 1/e² of the maximum intensity. A criterion for Rayleigh range based on the effective spot size woe for axisymmetric beams can be specified as non-diffracting or quasi-non-diffracting beams for forming defects in Equation (1), below:

$${Z}_{R} > {F}_{D} \frac{π {w}_{0 , eff}^{2}}{λ} \qquad ( 1 )$$

where F_{D} is a dimensionless divergence factor having a value of at least 10, at least 50, at least 100, at least 250, at least 500, at least 100, in the range of from 10 to 2000, in the range of from 50 to 1500, in the range of from 100 to 1000. For a non-diffracting or quasi—non-diffracting beam the distance Z_{R} in Equation (1), over which the effective beam size doubles, is F_{D} times the distance expected if a typical Gaussian beam profile were used. The dimensionless divergence factor F_{D} provides a criterion for determining whether or not a laser beam is quasi-non-diffracting. As used herein, the pulsed laser beam 32 is considered to be quasi-non-diffracting if the characteristics of the laser beam satisfy Equation (1) with a value F_{D}>10. As the value of F_{D} increases, the pulsed laser beam 32 approaches a more nearly perfectly non-diffracting state.

Further details regarding quasi-non-diffracting beams that can be used to generate the laser beam focal line are described in U.S. Patent Application Publication No. 2019/0382300 A1 to Bui et al., PCT Publication No. WO 2020/236447 A1 to Ivanov et al., and U.S. Pat. No. 11,052,481 to Boek et al., the entire disclosures of which are incorporated herein by reference as if reproduced herein in their entireties.

With reference now to FIG. 2, an exemplary operation of the laser processing system 10 is depicted. As depicted in FIG. 2, the laser system 26 (of which only the beam shaping optics 30 are shown in FIG. 2) can be translated relative to the glass sheet 12 in a translation direction 38 that corresponds to the desired contour line 22 in the glass sheet 12. As the laser system 26 is translated relative to the glass sheet 12, the Bessel-like laser beam 20 forms the plurality of defects 24 along the contour line 22. Directing the Bessel-like laser beam 20 into the glass sheet 12 causes portions of the glass sheet 12 that are exposed to the focal line 36 to fracture. For example the laser beam 20 deposits enough energy to break chemical bonds in the glass sheet 12 and form the defects 24 at spaced locations along the contour line 22.

As will be appreciated by those having skill in the art, the laser system 26 can be translated with respect to the glass sheet 12 by moving the glass sheet 12 (e.g., by moving a stage coupled to the glass sheet 12), by moving the laser system 26 (e.g., in order to move the focal line 36), or by moving both the glass sheet 12 and the focal line 36. By translating the laser focal line 36 relative to the glass sheet 12, the plurality of defects 24 can be formed in the glass sheet 12 along the desired contour line 22.

FIG. 3 shows a top view of the glass sheet 12 after the laser system 26 has been translated relative to the glass sheet 12 in order to form the defects 24. As shown in the embodiment of FIG. 3, the defects 24 are evenly spaced along the contour line 22 such that the glass sheet 12 can fracture along the contour line 22. When the glass sheet 12 fractures along the contour line 22 because of the presence of the defects 24, the glass sheet 12 separates into two or more sections as desired.

After the defects 24 are formed, the glass sheet 12 can be separated into separate sections along the contour line 22. In an example, separation along the contour line 22 is accomplished either by internal stress within the glass sheet 12 (e.g., if the glass sheet 12 is a tempered glass material) causing the glass sheet 12 to spontaneously self-separate along the contour line 22 or by introducing a separation force to the glass sheet 12, for example by exerting mechanical forces onto the glass sheet 12 (e.g., exerting a tension force) and/or by introducing thermal stress into the glass sheet 12, such as by unevenly heating and then cooling the glass sheet 12 to bring about crack formation and separation. In an example, thermal stress is induced by irradiating the glass sheet 12 with a CO2 laser along the contour line 22.

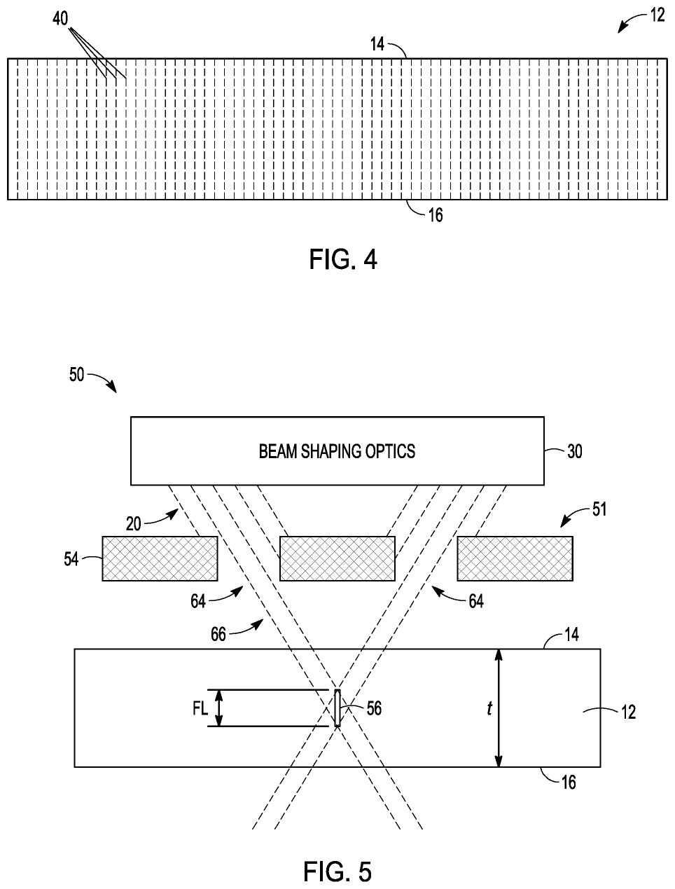

FIG. 4 shows an edge view of a section of the glass sheet 12 after laser processing by the laser processing system 10 and separation into two or more sheet sections. More specifically, FIG. 4 shows a side edge surface of the glass sheet 12 where it was separated along the contour line 22. As can be seen in FIG. 4, the separation of the glass sheet 12 along the contour line 22 results in laser traces 40 across the thickness of the glass sheet 12. It is noted that the laser traces 40 are due to the formation of the defects 24 in the glass sheet 12. Furthermore, it has been shown that micron-level cracks can form between adjacent laser traces 40, which can reduce edge strength of the separated sections of the glass sheet 12, particularly when the micro-cracks form at or near one of the major surfaces 14, 16. Additional grinding and polishing may be needed to mitigate the effect of these micro-sized cracks. Therefore, embodiments of the present disclosure comprise forming edge portions of the glass sheet 12 such that the laser traces 40 are provided in less than the entire thickness of the edge surface portions. Such increases the edge strength of the separated glass sheet 12.

As disclosed herein, laser traces 40 are elongated modifications or defects in glass sheet 12 with an average diameter of about 1 micron or less, or about 900 nm or less, or about 800 nm or less, or about 700 nm or less, or about 600 nm or less, or about 500 nm or less. In some embodiments, the length of laser traces 40 may be equal to the length of laser beam focal line 36. Furthermore, in some embodiments, the length of laser traces 40 is less than the thickness t of the glass sheet 12, as discussed further below.

Embodiments of the present disclosure comprise the laser processing system 10 that modifies the produced focal lines in order to alter the resulting defects, which in turn produces a separated glass sheet with enhanced edge strength. Specifically, the modification of the focal line changes the length of the focal line that the glass sheet encounters, so that the defects are only formed within a portion of the thickness of the glass sheet. In other words, the laser processing system 10 of the embodiments disclosed herein can be operated so that the focal line encounters only a portion of the glass sheet, rather than the focal line that extends throughout the entire thickness t of the glass sheet (it is noted that FIGS. 1 and 2 show a focal line that extends through the entire thickness t of the glass sheet). This results in a laser beam having a specified laser focus area that does not extend through the entire thickness of the glass sheet, which in turn forms a specified pattern of defects in the glass sheet along the contour line The specified pattern can include one or more specified first regions of the cross-section of the contour line that are processed by the Bessel-like laser beam and one or more specified second regions that are not altered by the laser processing system. The first regions include the defects 24 and may be referred to herein as “defect regions.” The second regions do not include the defects 24 and may be referred to herein as “unaffected regions.”

Furthermore, the embodiments of the present disclosure include altering the laser beam so that at least a portion of the one or more unaffected regions are located at or proximate to one or both of the major surfaces 14, 16 of the glass substrate 12. Specifically, at least a portion of the one or more unaffected regions are directly adjacent to or proximate to one or both of the major surfaces 14, 16, which is also referred to herein as at least a portion of the one or more unaffected regions being within a “near-surface area” of one or both of the major surfaces 14, 16. As used herein, the term “near-surface area” refers to a region that is within a specified distance from one of the major surfaces 14, 16, e.g., within about 20% of the thickness t of the glass sheet 12 from the major surface 14 or 16. Therefore, the minimum distance from the unaffected region to the major surface 14 or 16 is about 20% or less of the entire thickness t of the glass sheet 12. In other embodiments, the “near-surface area” is about 15% or less of the thickness t of the glass sheet 12, or about 10% or less of the thickness t of the glass sheet 12, or about 5% or less of the thickness t of the glass sheet, or about 2.5% or less of the thickness t of the glass sheet 12, or about 1% or less of the thickness t of the glass sheet 12.

Furthermore, the defect regions do not extend through the entire thickness t of the glass substrate 12. Because the unaffected regions are located adjacent to or proximate to at least one major surface 14, 16 and because the defect regions do not extend through the entire thickness t of the glass sheet 12, the glass sheet 12 has a higher edge strength along the cut edge of the glass substrate 12. Furthermore, the side edge of the cut portion of the glass sheet 12 (which was cut along the contour line 22) has a high-quality cut face with low surface roughness, a high degree of perpendicularity relative to one or both of the major surfaces 14, 16, and a low chipping size. In embodiments, the side edge of the cut portion of the glass sheet 12 has a degree of perpendicularity within about 0.1 degrees or less from perpendicular (normal) to the first major surface 14 or the second major surface 16, or both. Furthermore, the any chips formed during the laser cutting process are about 10 microns or less in diameter.

The defect regions are formed by the defects 24 and, thus, include the laser traces 40. However, the unaffected regions are portions of the glass sheet 12 (along the contour line 22) that were not altered by the laser beam 20. Therefore, the unaffected regions are not formed by the defects 24 and do not comprise the laser traces 40. Instead, these portions form “mirror-like regions” within the cut side edge of the glass sheet 12. As described herein “mirror-like regions” refers to regions of the glass sheet 12 that do not comprise the laser traces 40 and that have low surface roughness and high transmittance. More specifically, the mirror-like regions (the unaffected regions) have an arithmetical mean surface roughness Ra of less than about 500 nm, or less than about 250 nm, or less than about 200 nm, or less than about 150 nm, or less than about 100 nm, or less than about 50 nm, or less than about 40 nm, or less than about 30 nm, or less than about 25 nm, or less than about 20 nm, or less than about 15 nm, or less than about 10 nm. In some embodiments, the surface roughness Ra is from about 10 nm to about 500 nm, or from about 15 nm to about 100 nm, or from about 25 nm to about 50 nm. In addition, or alternatively, at least a portion of the mirror-like regions of the unaffected regions can each have a different surface roughness Ra value relative to a different portion. For example, a first mirror-like region can have a different surface roughness Ra from a second mirror-like region.

In comparison, the defect regions have a relatively higher surface roughness Ra than the mirror-like regions (the unaffected regions). For example, in embodiments, the defect regions have a surface roughness Ra of about 500 nm or greater, or about 600 nm or greater, or about 700 nm or greater, or about 800 nm or greater, or about 900 nm or greater, or about 1 micron or greater, or about 1.25 microns or greater, or about 1.5 microns or greater. In some embodiments, the surface roughness Ra of the defect regions is in a range from about 1 micron to about 1.5 microns, or from about 1.1 microns to about 1.4 microns.

The arithmetical mean surface roughness Ra, as defined herein, is a component of a surface's texture. As outlined in the ISO 4287:1997 standard, the arithmetical mean surface roughness Ra is the arithmetic average value of filtered roughness profiles determined from deviations about a center line within an evaluation length.

As discussed above, the mirror-like regions resulting from the unaffected regions exhibit a high transmittance of light compared to the defect regions. For example, the mirror-like regions exhibit a relatively high transmittance of visible light (300 nm to 600 nm). In some embodiments, the mirror-like regions exhibit a transmittance of visible light of at least about 75%, or at least about 80%, or least about 82%, or at least about 84%, or at least about 85%, or at least about 87%, or at least about 89%, or at least about 90%, or at least about 92%, or at least about 95%, or at least about 98%, as measured according to ISO 9050 standard.

The mirror-like regions of the unaffected regions that are adjacent to or proximate to a major surface 14, 16 of the glass substrate 12 provide substantial improvement in edge strength. More specifically, the mirror-like regions, as disclosed herein, provide enhanced edge strength to a glass substrate compared to a mirror-like region that is not disposed within a “near-surface area,” as defined above. Therefore, the mirror-like regions, as disclosed herein, reduce the need for downstream edge grinding and polishing, which reduces process time and cost.

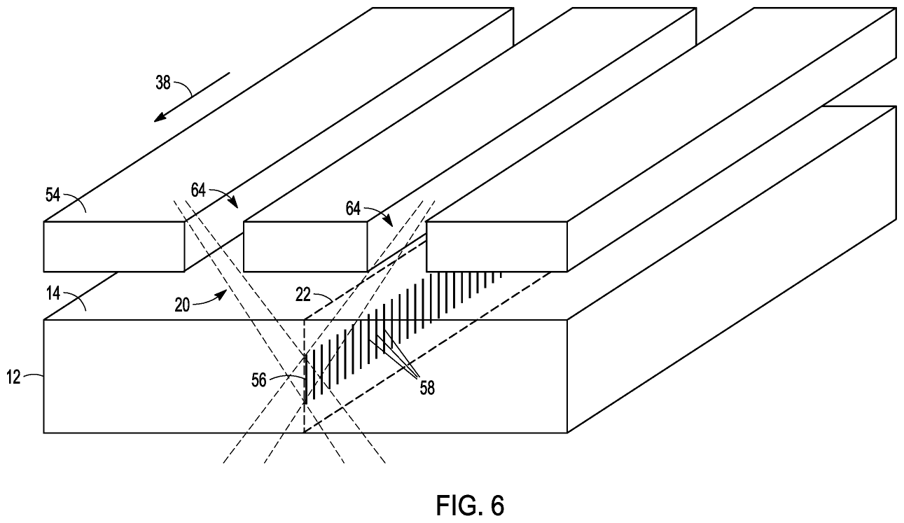

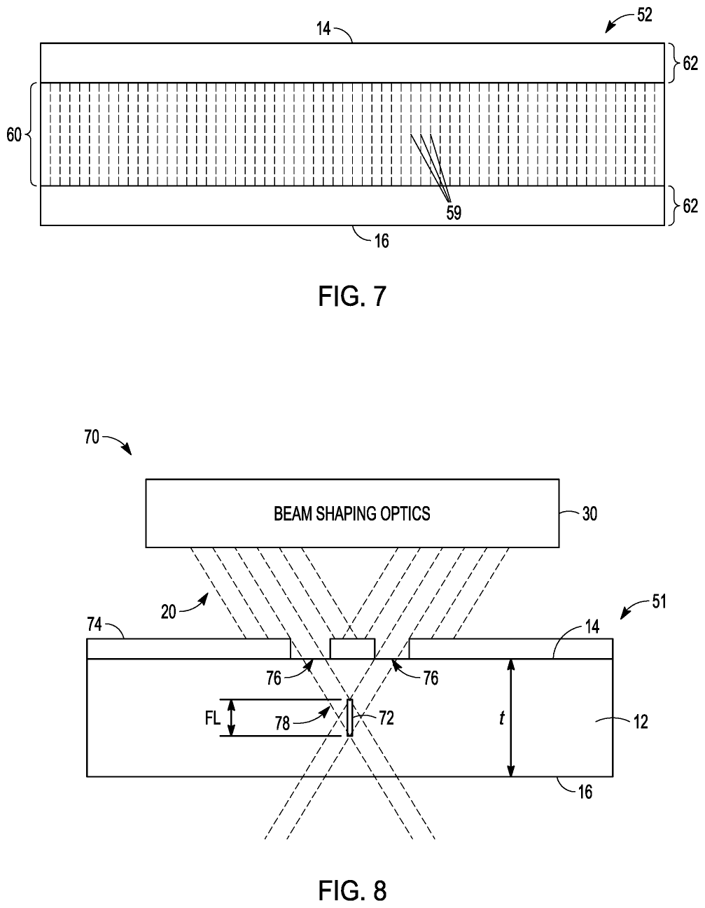

FIGS. 5 and 6 show an exemplary laser processing system 50, according to the embodiments disclosed herein, that is configured to produce a specified pattern of the one or more defect regions and the one or more unaffected regions described above by altering the length of the laser focal line that is emitted onto the glass sheet 12. FIG. 7 shows a patterned edge 52 that results after laser processing with the exemplary processing system of FIGS. 5 and 6 and subsequent separation of the glass sheet 12 into separate glass pieces. Thus, the patterned edge 52 is a cut and separated portion of the glass sheet 12 after it has been cut and separated along the contour line 22. It is noted that the laser processing system 50 includes the components of laser processing system 10 (as discussed above) with the additional components disclosed below.

In FIGS. 5 and 6, the exemplary laser processing system 50 includes beam shaping structure 51 that is configured to modify a length of the focal line 56 that the glass sheet 12 encounters, and therefore produces a defect 58 with a specific size and location. As disclosed above, a plurality of defects 58 form the contour line 22. The beam shaping structure 51 alters the length of the focal line 56 by blocking portions of the Bessel-like laser beam 20 after it is emitted from the beam shaping optics 30 (not shown in FIG. 6). As the laser system 26 moves in the translation direction 38 along the contour line 22, defects 58 are formed along the contour line 22, such that a resulting defect region 60 (FIG. 7) is formed comprising a plurality of laser traces 59 (which are formed from the defects 58). As shown in FIGS. 5 and 6, the focal line 56 of the laser beam 20 extends through less than the entire thickness t of the glass sheet 12. Therefore, the corresponding defects 58 each have a length that is less than the thickness t of the glass sheet 12.

As shown in FIG. 7, the defects 58 form laser traces 59 in the defect region 60, similar to the laser traces 40 described above with respect to FIG. 4. The defects 58 are only formed in defect region 60. Therefore, the laser traces 59 are also formed only in the defect region 60. Furthermore, the defects 58 and laser traces 59 are positioned in an interior portion of the glass sheet 12. Thus, they are spaced apart from the major surfaces 14, 16.

In some examples, the defects 58 are located outside of the tensile stress layer or layers of a strengthened glass sheet 12, e.g., a glass sheet 12 having at least one tensile stress layer and at least one compression stress layer.

The formation of the defect region 60 by the laser beam 20 also results in unaffected regions 62 that are not altered by the laser beam 20. These unaffected regions 62 form the mirror-like regions in the separated edge of the glass sheet 12, as discussed above.

Referring again to FIGS. 5 and 6, in some embodiments, the beam shaping structure 51 comprises a fixture 54 disposed between the beam shaping optics 30 and the glass sheet 12. The fixture 54 is made from a material that isolates the wavelength of the laser beam 20 so that the when the laser beam 20 encounters the fixture 54, the wavelength is not transmitted through the material of the fixture 54. Also, the material of the fixture 54 is not altered by the laser beam 20, e.g., the laser beam 20 does not damage the fixture 54. Examples of materials that can be used to form the fixture 54 include, but are not limited to, metals, polymers, and the like. Exemplary materials include, for example, aluminum, ionized aluminum, brass, titanium, copper, chromatic materials, polycarbonate, polyvinyl chloride, and ceramics.

The fixture 54 includes openings 64 through which specified portions 66 of the laser beam 20 pass. The specified portions 66 of the laser beam 20 interact to form the focal line 56 with a reduced length. The focal line 56 has a length FL that is smaller than the total thickness t of the glass sheet 12, and, therefore, the resulting reduced-length defects 58 are only formed across a portion of the thickness t of the glass sheet 12. The fixture 54 and the openings 64 therein can be positioned so that the reduced-length defects 58 are located at a specified location within the glass sheet 12 to form the defect region 60 at a desired depth within the glass sheet 12. As can be seen in FIG. 6, in embodiments, a length of the openings 64 extends in a direction that is parallel to the translation direction 38 (e.g., the direction 38 that the laser system 26 is translated relative to the glass sheet 12), which is also parallel to the contour line 22 such that, in the example of FIGS. 5-7, the defect region 60 extends along substantially the entirety of the contour line 22.

FIG. 8 shows another exemplary laser processing system 70 that alters the length of a focal line 72 that the glass sheet 12 encounters. It is noted that the laser processing system 70 includes the components of laser processing system 10 (as discussed above) with the additional components disclosed below. In the laser processing system 70 of FIG. 8, the beam shaping structure 51 is a film 74 that is positioned on the first major surface 14 of the glass sheet 12. In an example, the film 74 can be formed directly onto the first major surface, such as by printing, spray coating, deposition, or otherwise formed onto the first major surface 14 by any means known in the art. In another example, the film 74 is formed separately and is then placed onto the first major surface 14. Similar to the fixture 54 described above, the film 74 can be made from any material that effectively isolates the wavelength of the laser beam 20 so that the wavelength is not transmitted through the material of the film 74. Examples of materials that can be used to form the film 74 include, but are not limited to, metals, polymers, and the like. Exemplary materials include, for example, aluminum, ionized aluminum, brass, titanium, copper, chromatic materials, polycarbonate, polyvinyl chloride, and ceramics.

As shown in FIG. 8, the film 74 performs the same function as the fixture 54 in FIGS. 5 and 6. Specifically, the film 74 includes openings 76 that permit specified portions 78 of the laser beam 20 to pass through the openings 76, while the rest of the laser beam 20 is blocked by the material of the film 74 and is not emitted onto the glass sheet 12. The openings 76 are sized and positioned so that a focal line 72 with a reduced length FL alters a specified interior portion of the glass sheet 12, thus producing the defect region 60. It is noted that the film 74 of FIG. 8 can produce the same patterned edge 52 with the same size and location of the defect regions 60 and the unaffected regions 62 as shown in FIG. 7.

It is noted that fixture 54 may be used multiple times with different glass sheets 12. However, in some embodiments, because film 74 is applied directly to the glass sheet 12, it may be discarded after use. In other embodiments, film 74 may be washed in order to be reused with different glass sheets 12. It is further noted that film 74 may be used in the processing of a glass sheet 12, rather than fixture 54, when a more detailed cutting and shaping of the glass sheet 12 is required.

As shown in FIGS. 5, 6, and 8, the reduced-length focal lines 56, 72 can be sized and positioned to be located generally at a central position within the glass sheet 12. As the laser system 26 is translated relative to the glass sheet 12 in the translation direction 38 (e.g., out of the page as depicted in FIGS. 5 and 8), the resulting contour line 22 will result in the patterned edge 52, as shown in FIG. 7, when the glass substrate 12 is subsequently cut and separated along the contour line 22. In the embodiment of FIG. 7, the patterned edge 52 comprises a central defect region 60 formed by a plurality of defects 58, and two edge unaffected regions 62 each located at or proximate to the first and second major surfaces 14, 16. In the embodiment of FIG. 7, each unaffected region 62 has a thickness that is from about 5% to about 25% of the thickness t of the glass sheet 12, such as from about 10% to about 20% of thickness t of the glass sheet, and the central defect region 60 has a thickness that is from about 50% to about 90% of the thickness t of the glass sheet 12, such as from about 60% to about 80% of the thickness t of the glass sheet.

After forming the laser pattern and laser processing the glass sheet 12, the glass sheet 12 can be separated along the contour line 22, for example by the application of thermal stress (e.g., through the use of a heating infrared or CO2 laser) or mechanical stress to induce separation along the contour line 22. In some examples, internal stress within the glass sheet 12 can cause spontaneous self-separation along the contour line 22, as described above.

Altering the position of the focal line 56, 72 within the glass sheet 12 results in different patterned edges 52 of the defect regions 60 and the unaffected regions 62, wherein at least a portion of the unaffected region or regions 62 are adjacent to or proximate to one or both of the major surface 14, 16 of the glass sheet 12 (e.g., so that at least a portion of the unaffected region or regions 62 is within a near-surface area relative to the major surface 14 and/or 16).

As discussed above, after separation of the glass sheet 12 along the contour line 22, the unaffected regions 62 form the mirror-like regions with little or no defects or modifications. For example, unaffected regions 62 do not comprise laser traces 40, which (as discussed above) form modifications or defects in glass sheet 12.

Furthermore, forming the patterned edge 52 comprising the one or more unaffected regions 62 adjacent to or proximate to the major surfaces 14 and/or 16 results in an increased edge strength for the cut glass sheet 12. More specifically, the cut glass sheet 12 has an edge strength that is stronger than a comparable glass sheet with a cut edge formed of only a defect region that extends the entire thickness of the glass sheet. The stronger edge strength of the embodiments disclosed herein require less post-processing (e.g., with reduced or even eliminated grinding or polishing), which can decrease the overall unit cost for producing cut glass articles with high edge strength. Also, because the process of forming the patterned edge 52 can be achieved by modifying essentially only the optics (to form the specified portions 66, 78 of the laser beam 20 that are emitted onto the glass sheet 12 in order to form the specified pattern of the defect regions 60 and the unaffected regions 62), there is little modification of the full fabrication process. Therefore, an existing laser-cutting system can be easily modified to perform the processes of the present disclosure.

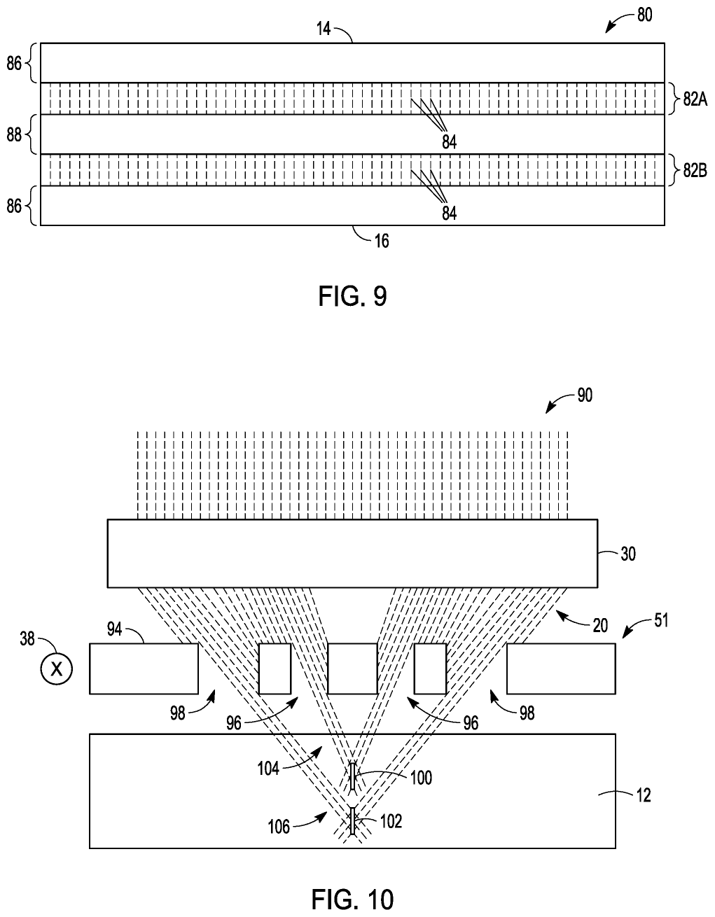

FIG. 9 shows an end view of another patterned edge 80 that can be formed by altering the portion of the glass sheet 12 exposed to the focal line during the laser processing processes disclosed herein. The patterned edge 80 of FIG. 9 includes two generally centralized defect regions 82A, 82B comprising a plurality of laser traces 84 (formed by the defects during exposure of the glass sheet 12 to the laser focal lines) and three unaffected regions 86, 88 formed at the regions that are not altered by the laser focal lines. As discussed above, the unaffected regions 86, 88 form the mirror-like regions. Two of the unaffected regions 86 are located adjacent to and proximate to the major surfaces 14, 16 of the glass sheet 12, and the unaffected region 88 is centrally located between the two defect regions 82A, 82B.

FIG. 10 shows a cross-sectional view of a laser processing system 90 that can form the patterned edge 80 of FIG. 9. It is noted that the laser processing system 90 includes the components of laser processing system 10 (as discussed above) with the additional components disclosed below. As can be seen in FIG. 10, the laser processing system 90 includes a beam shaping structure 51 that comprises a fixture 94, which is similar to the fixture 54 of FIG. 5 in that the fixture 94 includes openings 96, 98 that alter the laser focal line emitted onto the glass sheet 12. In some embodiments, the fixture 94 of FIG. 10 includes a first, or inner set of laser openings 96 that correspond to a first or upper focal line 100, and a second, or outer set of laser openings 98 that correspond to a second or lower focal line 102. The upper focal line 100 forms the defects of the upper defect region 82A and the lower focal line 102 forms the defects of the lower defect region 82B, as shown in FIG. 9.

Similar to the exemplary openings 64 of the fixture 54 (as shown in FIGS. 5 and 6), a length of the openings 96, 98 in the exemplary fixture 94 of FIG. 10 extends in a direction that is parallel to the translation direction 38 (e.g., into or out of the page in FIG. 10), which is the direction that the laser system 26 is translated relative to the glass sheet 12. Similar to the fixture 54 (as shown in FIGS. 5 and 6), the fixture 94 blocks portions of the laser beam 20 and the openings 96, 98 permit specified portions 104, 106 of the laser beam 20 to be emitted onto the glass sheet 12 as the focal lines 100, 102. For example, the first openings 96 permit a first portion 104 of the laser beam 20 to pass through the fixture 94, wherein the first portion 104 of laser beam 20 forms the upper focal line 100, which in turn forms the defects of the upper defect region 82A. Furthermore, the second openings 98 permit a second portion 106 of the laser beam 20 to pass through the fixture 94 and the second portion 106 of the laser beam 20 forms the lower focal line 102, which in turn forms the defects of the lower defect region 82B.

Openings 98 may have a different size from openings 96. For example, as shown in FIG. 10, openings 98 may have a longer length (in a direction perpendicular to the translation direction 38) than openings 96. It is also contemplated that the upper and lower focal lines 100, 102 may be formed by a film (similar to film 74 but with openings 96, 98 formed therein), rather than fixture 94 to form the upper and lower focal lines 100, 102.

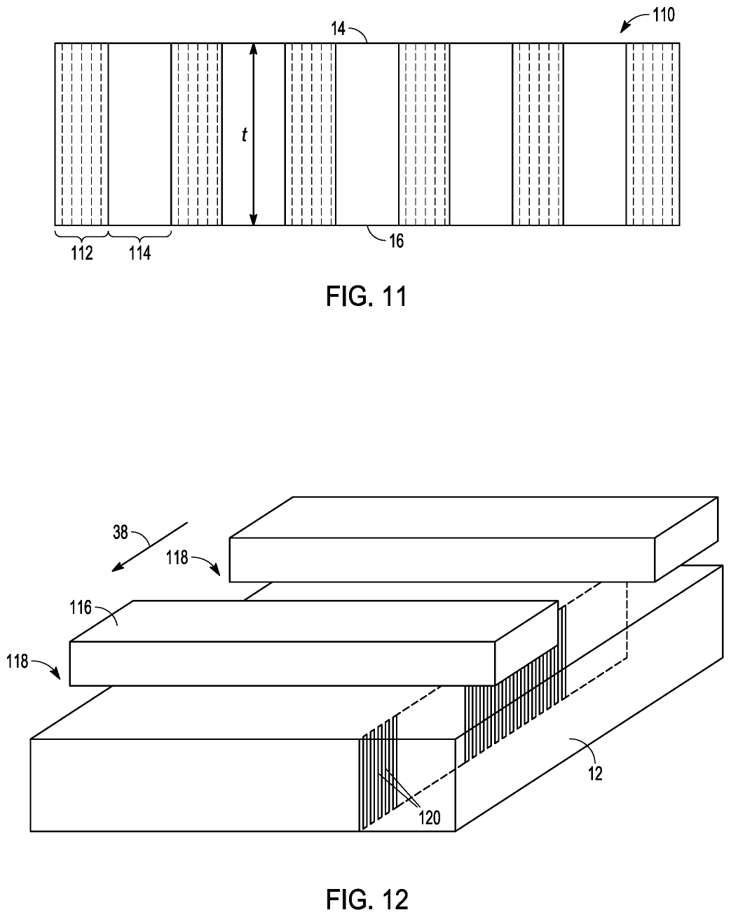

FIG. 11 shows an end view of another patterned edge 110 that includes alternating defect regions 112 and unaffected regions 114 that each extend across the entire thickness t of the glass sheet 12 (i.e., from the top major surface 14 to the bottom major surface 16). FIG. 12 shows a portion of a fixture 116 that can be used to form the patterned edge 110 of FIG. 11. In an example, the fixture 116 includes openings 118 that perform a similar function to the openings 64, 96, 98 in the fixtures 54, 94 in FIGS. 5, 6, and 10, i.e., the openings 116 allow a laser beam (e.g., the Bessel-like laser beam 20) to pass through the fixture 116 such that the laser beam is emitted onto specified portions of the glass sheet 12. The openings 118 in the fixture 116 differ from openings 64, 96, 98 of the fixtures 54, 94 in that the length of the openings 118 in the fixture 116 of FIG. 12 extends in a direction that is angled relative to the translation direction 38 (e.g., the direction that the laser system 26 is translated during laser processing along the contour line 22). In an example, as shown in FIG. 12, the angled openings 118 are perpendicular relative to the translation direction 38. The angled openings 118 are such that as the laser system 26 is translated relative to the glass sheet 12, the resulting laser beam (e.g., the Bessel-like laser beam 20) will either be entirely blocked by the fixture 116 (resulting in the unaffected regions 114 that extend throughout the entire thickness t of the glass sheet 12) or the laser beam will be entirely emitted onto the glass sheet 12 (resulting in defects 120 (FIG. 12) which form the defect regions 112 of the patterned edge 110, wherein the defect regions 112 extend throughout the entire thickness t of the glass sheet 12). The angled openings 118 are such that the laser beam encounters alternating sections of the fixture 116 and the openings 118, which results in the alternating defect regions 112 and unaffected regions 114 after separation.

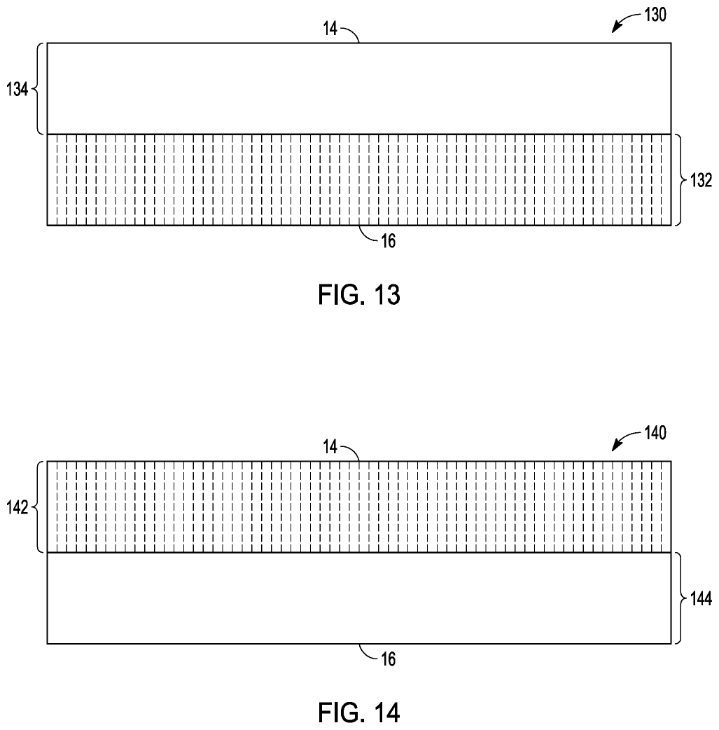

FIGS. 13-16 show end views of various examples of other patterned edges that can be formed by altering the portion of the laser focal line to which the glass sheet 12 is exposed during laser processing.

FIGS. 13 and 14 show examples of patterned edges 130, 140 wherein there is an elongated defect region 132, 142 located proximate to one of the major surfaces 14, 16 and an elongated unaffected region 134, 144 located adjacent to or proximate to the other major surface 14, 16. For example, in FIG. 13, the patterned edge 130 includes an elongated unaffected region 134 that is located adjacent to and proximate to the first or upper major surface 14 and an elongated defect region 132 that is located adjacent to and proximate to the second or lower major surface 16. Conversely, in the example patterned edge 140 shown in FIG. 14, an elongated defect region 142 is located adjacent to and proximate to the first or upper major surface 14 and an elongated unaffected region 144 is located adjacent to and proximate to the second or lower major surface 16. In each instance, the patterned edge 130, 140 can be formed with a beam shaping structure 51 with a pair of openings that extend in a direction that is parallel to the translation direction 38. However, as compared with the beam shaping structure 51 of FIG. 5, the pair of openings are shifted so that the defect regions 132, 142 are located at or proximate to one of the major surfaces 14, 16 rather than in the middle of the glass sheet 12, while the unaffected regions 134, 144 located at or proximate to the other major surface 14, 16 remain unaltered by the specified laser focal line.

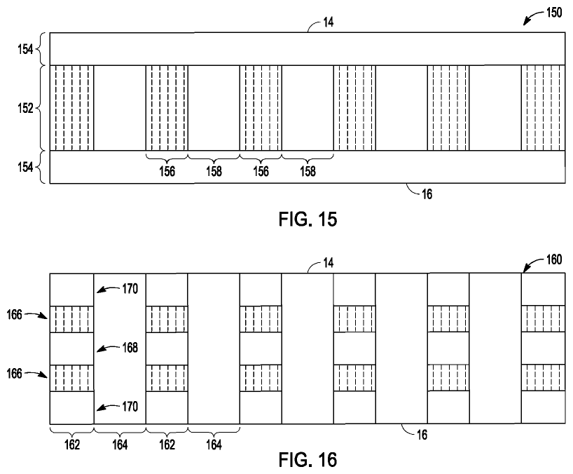

FIGS. 15 and 16 show examples of patterned edges wherein two or more of the prior patterned edges are combined. For example, FIG. 15 shows an exemplary patterned edge 150 that is a combination of the patterned edge 52 of FIG. 7 and the patterned edge 110 of FIG. 11. The patterned edge 150 of FIG. 15 includes a central affected zone 152 with a pair of unaffected regions 154 located above and below the central affected zone 152, e.g., with at least a portion of the unaffected regions 154 being within the near-surface area that is proximate to the major surfaces 14, 16. The central affected zone 152 includes an alternating pattern of defect regions 156 and central unaffected regions 158. FIG. 16 shows another exemplary patterned edge 160 that is a combination of the patterned edge 80 of FIG. 9 and the patterned edge 110 of FIG. 11. The patterned edge 160 of FIG. 16 includes an alternating pattern of affected zones 162 and unaffected regions 164, wherein the unaffected regions 164 extend from the first major surface 14 to the second major surface 16. Each affected zone 162 includes two generally centralized defect regions 166 and three unaffected regions 168, 170 formed at the regions that are unaffected by the laser focal lines. A first affected region 168 is centrally located between the two defect regions 166, and the other two unaffected regions 170 are located proximate to the major surfaces 14, 16 of the glass sheet 12, e.g., with at least a portion of the unaffected regions 170 being within a near-surface area relative to the major surfaces 14, 16.

In an example, the beam shaping structure 51 that is able to form the patterned edges 52, 80, 110, 130, 140, 150, or 160 of any one of FIG. 7, 9, 11, or 13-16 can include a holding mechanism to hold the beam shaping structure 51 in predetermined positions relative to the laser system 26 and the contour line 22 of the glass sheet 12. The predetermined positions of the holding mechanism can be selected such that the openings of the beam shaping structure 51 are located in specified positions relative to the laser system 26 and the contour line 22 such that the openings provide for the desired defect regions and unaffected regions of the resulting patterned edge.

The actual specified pattern of the defect regions and the resulting patterned edge is not important, so long as sufficient defects are formed to separate the glass sheet 12 into separate pieces and such that there is enough of the unaffected edge proximate to a major surface to provide for enhanced edge strength. In some examples, the pattern that is chosen provides for spontaneous self-separation of the glass sheet 12, i.e., due to internal mechanical stress in the glass sheet 12 because it is a strengthened glass material, such as chemically tempered glass.

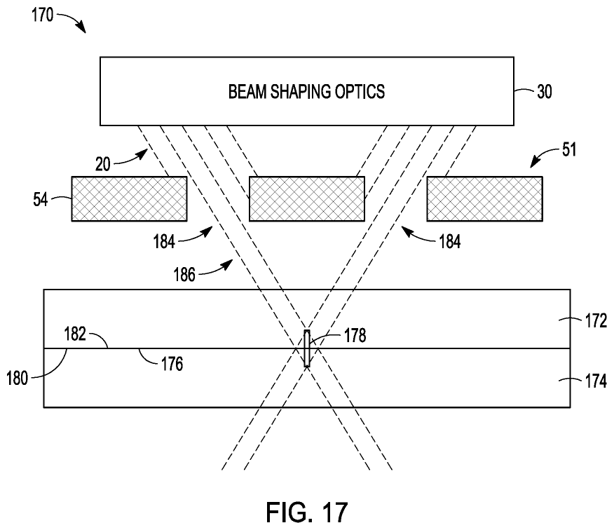

FIG. 17 shows an exemplary laser processing system 170 for joining or bonding a first transparent workpiece 172, e.g., a first glass sheet 172, to a second transparent workpiece 174, e.g., a second glass sheet 174. As discussed above, each of first glass sheet 172 and second glass sheet 174 comprise a first major surface and an opposing second major surface. Similar to the other laser processing systems described herein, the laser processing system 170 uses a quasi-non-diffracting laser beam 20, such as a Bessel-like laser beam 20, which is modified by a beam shaping structure 51. As discussed above, the beam shaping structure 51 is configured to size and position a resulting laser beam focal line 178. However, in the embodiment of FIG. 17, the laser focal line 178 extends from the first transparent workpiece 172 across a contact region 176 between the first and second transparent workpieces 172, 174 (e.g., where a bottom surface 180 (the second major surface) of the first transparent workpiece 172 is in direct contact with a top surface 182 (the first major surface) of the second transparent workpiece 174) and into the second transparent workpiece 174. The focal line 178 modifies the material of the first and second transparent workpieces 172, 174 across the contact region 176 to form a weld region that bonds or holds the transparent workpieces 172, 174 together. More specifically, the focal line 178 forms the weld region across the contact region 176. Without wishing to be bound by any theory, it is believed that the weld region is formed by melting or modifying the materials of the first and second transparent workpieces 172, 174 across the contact region 176.

The structure of the weld region is physically joined to the bulk material of the each of the transparent workpieces 172, 174 in order to physically bond or join the first transparent workpiece 172 to the second transparent workpiece 174 via the weld region. In some embodiments, the weld region, as formed by the focal line, provides a chemical bond between the structure of the weld region and the bulk material of the first transparent workpiece 172 and forms a chemical bond between the structure of the weld region and the bulk material of the second transparent workpiece 174. Translation of the laser system 28 along a translation direction 38 allows each pulse of the laser beam 20 to produce a separate weld region at different locations along the contact region 176 in order to further bond the first transparent workpiece 172 to the second transparent workpiece 174.

As shown in FIG. 17, focal line 178 is longer than a length of contact region 176. Furthermore, the length of focal line 178 is smaller than a combined thickness of first transparent workpiece 172 and second transparent workpiece 174.

In some embodiments, the beam shaping structure 51 of FIG. 17 comprises a fixture 54 that is similar to the fixture 54 of FIGS. 5 and 6 or the film 74 of FIG. 8 (except that the beam shaping structure 51 of FIG. 17 is configured and positioned so that its resulting focal line 178 is located at the contact region 176 between the first and second transparent workpieces 172, 174 rather than in a middle region of a single transparent workpiece). For example, the beam shaping structure 51 of FIG. 17 can include openings 184 through which specified portions 186 of the laser beam 20 pass. The beam shaping structure 51 of FIG. 17 is configured and positioned so that specified portions 186 of the laser beam 20 interact to form the focal line 178 positioned as described above, i.e., so that a portion of the first transparent workpiece 172 proximate to the surface 180 and a corresponding portion of the second transparent workpiece 174 proximate to the surface 182 are encountered by the focal line 178 in order to form the weld region described above.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code can form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) can be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A method of producing an article, the method comprising:
positioning a beam shaping structure relative to a transparent workpiece, the transparent workpiece having a first major surface and a second major surface, the first major surface opposing the second major surface with a thickness therebetween, wherein the beam shaping structure comprises a specified pattern of openings;
emitting a laser beam toward the first major surface of the transparent workpiece such that portions of the laser beam pass through the openings and form corresponding laser beam focal lines across a portion of the transparent workpiece,
a length of each laser beam focal line being less than the thickness of the transparent workpiece, and
the laser beam focal lines forming a plurality of defects in the transparent workpiece disposed along a contour line; and
separating the transparent workpiece along the contour line to provide a first workpiece section and a second workpiece section,
wherein the separating of the transparent workpiece forms a cut edge surface on each of the first and second workpiece sections, each cut edge comprising a defect region and an unaffected region, the defect region having a higher surface roughness than the unaffected region and a minimum distance of the unaffected region to the first major surface being about 20% or less of the thickness between the first major surface and the second major surface.

2. The method of claim 1, wherein the surface roughness of the defect region is about 500 nm or greater and the surface roughness of the unaffected region is less than 500 nm.

3. The method of claim 2, wherein the surface roughness of the defect region is about 900 nm or greater and the surface roughness of the unaffected region is less than 250 nm.

4. The method of claim 1, wherein the surface roughness of the defect region is in a range from about 1 micron to about 1.5 microns.

5. The method of claim 1, wherein the unaffected region has a higher transmittance of visible light than the defect region.

6. The method of claim 1, wherein a transmittance of visible light of the unaffected region is about 85% or greater.

7. The method of claim 6, wherein the transmittance of visible light of the unaffected region is about 90% or greater.

8. The method of claim 7, wherein the transmittance of visible light of the unaffected region is about 92% or greater.

9. The method of claim 1, wherein the defects in the transparent workpiece form laser traces in the defect region.

10. The method of claim 9, wherein the unaffected region does not comprise laser traces.

11. The method of claim 1, wherein the defects in the transparent workpiece correspond to form the defect region.

12. The method of claim 1, wherein a length of each defect is less than the thickness between the first major surface and the second major surface.

13. The method of claim 1, wherein the minimum distance of the unaffected region to the first major surface is about 10% or less of the thickness between the first major surface and the second major surface.

14. The method of claim 1, wherein the beam shaping structure comprises a fixture, the method further comprising positioning the fixture at a predetermined distance from the first major surface.

15. The method of claim 1, wherein the beam shaping structure comprises a film, the method further comprising depositing the film on the first major surface.

16. The method of claim 1, wherein the unaffected region is directly adjacent to the first major surface.

17. The method of claim 1, further comprising forming a second unaffected region in the cut edge surface, the defect region having a higher surface roughness than the second unaffected region and a minimum distance of the second unaffected region to the second major surface being about 20% or less of the thickness between the first major surface and the second major surface.

18. The method of claim 17, further comprising a second defect region, the second defect region having a higher surface roughness than the unaffected region and the second unaffected region.

19. A method of producing an article, the method comprising:
positioning a beam shaping structure relative to a first transparent workpiece and a second transparent workpiece,
the first transparent workpiece contacting the second transparent workpiece at a contact region,
the first transparent workpiece having a first thickness and the second transparent workpiece having a second thickness,
the first transparent workpiece having a first major surface and a second major surface, and
the beam shaping structure comprising a specified pattern of openings; and
emitting a laser beam toward the first major surface of the first transparent workpiece such that portions of the laser beam pass through the openings and form a corresponding laser beam focal line across the contact region,
a length of the laser beam focal line being less than the thickness of first transparent workpiece and the thickness of the second transparent workpiece combined.

20. The method of claim 19, wherein the laser beam focal line forms a weld region across the contact region.
